(19) United States
(12) Patent Application Publication
(10) Pub. No.: US 2008/0291279 A1
(43) Pub. Date: Nov. 27, 2008

(54) Method and System for Performing Video Flashlight

(75) Inventors: Supun Samarasekera, Princeton, NJ (US); Keith Hanna, Princeton Junction, NJ (US); Harpreet Sawhney, West Windsor, NJ (US); Rakesh Kumar, Monmouth Junction, NJ (US); Aydin Arpa, Plainsboro, NJ (US); Vincent Paragano, Yardley, PA (US); Thomas Germano, Princeton Junction, NJ (US); Manoj Aggarwal, Plainsboro, NJ (US)

Correspondence Address: TIAJOLOFF & KELLY, CHRYSLER BUILDING, 37TH FLOOR, 405 LEXINGTON AVENUE, NEW YORK, NY, 10174, US

(73) Assignee: L-3 Communications Corporation, New York, NY (US)

(21) Appl. No.: 11/628,377

(22) PCT Filed: Jun. 1, 2005
(86) PCT No.: PCT/US05/19672

§ 371 Date: Dec. 1, 2006

Related U.S. Application Data
(60) Provisional application No. 60/575,894, filed on Jun. 1, 2004.
(60) Provisional application No. 60/575,895, filed on Jun. 1, 2004.
(60) Provisional application No. 60/576,050, filed on Jun. 1, 2004.

(51) Int. Cl. H04N 7/18

(52) U.S. Cl. 348/159; 348/E07.085

(57) ABSTRACT

In an immersive surveillance system, videos or other data from a large number of cameras and other sensors is managed and displayed by a video processing system overlaying the data within a rendered 2D or 3D model of a scene. The system has a viewpoint selector configured to allow a user to selectively identify a viewpoint from which to view the site. A video control system receives data identifying the viewpoint and based on the viewpoint automatically selects a subset of the plurality of cameras that is generating video relevant to the view from the viewpoint, and causes video from the subset of cameras to be transmitted to the video processing system. As the viewpoint changes, the cameras communicating with the video processor are changed to hand off to cameras generating relevant video to the new position. Playback in the immersive environment is provided by synchronization of time stamped recordings of video. Navigation of the viewpoint on constrained paths in the model or map-based navigation is also provided.

### RELATED APPLICATIONS

This application claims priority of U.S. provisional application Ser. No. 60/575,895 filed Jun. 1, 2004 and entitled “METHOD AND SYSTEM FOR PERFORMING VIDEO FLASHLIGHT”, U.S. provisional patent application Ser. No. 60/575,894, filed Jun. 1, 2004, entitled “METHOD AND SYSTEM FOR WIDE AREA SECURITY MONITORING, SENSOR MANAGEMENT AND SITUATIONAL AWARENESS”, and U.S. provisional application Ser. No. 60/576,050 filed Jun. 1, 2004 and entitled “VIDEO FLASHLIGHT/VISION ALERT”.

### FIELD OF THE INVENTION

The present invention generally relates to image processing, and, more specifically, to systems and methods for providing immersive surveillance, in which videos from a number of cameras in a particular site or environment are managed by overlaying the video from these cameras onto a 2D or 3D model of a scene.

### BACKGROUND OF THE INVENTION

Immersive surveillance systems provide for viewing of systems of security cameras at a site. The video output of the cameras in an immersive system is combined with a rendered computer model of the site. These systems allow the user to move through the virtual model and view the relevant video automatically present in an immersive virtual environment which contains the real-time video feeds from the cameras. One example of such a system is the VIDEO FLASHLIGHT™ system shown in U.S. published patent application 2003/0085992 published on May 8, 2003, which is herein incorporated by reference.

Systems of this type can encounter a problem of communications bandwidth. An immersive surveillance system may be made up of tens, hundreds or even thousands of cameras all generating video simultaneously. When streamed over the communications network of the system or otherwise transmitted to a central viewing station, terminal or other display unit where the immersive system is viewed, this collectively constitutes a very large amount of streaming data. To accommodate this amount of data, either a large number of cables or other connection systems with a large amount of bandwidth must be provided to carry all the data, or else the system may encounter problems with the limits of the data transfer rate, meaning that some video that is potentially of significance to the security personnel, might simply not be available at the viewing station or terminal for display, lowering the effectiveness of the surveillance.

In addition, earlier immersive systems did not provide for immersive playback of the video of the system, but only for the user to view current video from the cameras, or to replay the previously displayed immersive imagery without any freedom to change location.

Also, in such systems the user navigates essentially without restrictions, usually by controlling his or her viewpoint with a mouse or joystick. Although this gives a great freedom of investigation and movement to the user, it also allows a user to essentially get lost in the scene being viewed, and have difficulty moving the point of view back to a useful position.

### SUMMARY OF THE INVENTION

It is accordingly an object of the invention here to provide a system and a method for an immersive video system that improves the system in these areas.

In one embodiment, the present invention generally relates to a system and method for providing a system for managing large numbers of videos by overlaying them within a 2D or 3D model of a scene, especially in a system such as that shown in U.S. published patent application 2003/0085992, which is herein incorporated by reference.

According to an aspect of the invention, a surveillance system for a site has a plurality of cameras each producing a respective video of a respective portion of the site. A viewpoint selector is configured to allow a user to selectively identify a viewpoint in the site from which to view the site or a part thereof. A video processing system is coupled with the viewpoint selector so as to receive therefrom data indicative of the viewpoint, and coupled with the plurality of cameras so as to receive the videos therefrom. The video processing system has access to a computer model of the site. The video processing system renders from the computer model real-time images corresponding to a view of the site from the viewpoint, in which at least a portion of at least one of the videos is overlaid onto the computer model. The video processing system displays the images in real time to a viewer. A video control system receives data identifying the viewpoint and based on the viewpoint automatically selects a subset of the plurality of cameras that is generating video relevant to the view of the site from the viewpoint rendered by the video processing system, and causes video from the subset of cameras to be transmitted to the video processing system.

According to another aspect of the invention, a surveillance system for a site has a plurality of cameras each generating a respective data stream. Each data stream includes a series of video frames each corresponding to a real-time image of a part of the site, and each frame has a time stamp indicative of a time when the real-time image was made by the associated camera. A recorder system receives and records the data streams from the cameras. A video processing system is connected with the recorder and provides playback of the recorded data streams. The video processing system has a renderer that during playback of the recorded data streams renders images for a view from a playback viewpoint of a model of the site and applies thereto the recorded data streams from at least two of the cameras relevant to the view. The video processing system includes a synchronizer receiving the recorded data streams from the recorder system during playback. The synchronizer distributes the recorded data streams to the renderer in synchronized form so that each image is rendered with video frames all of which were taken at the same time.

According to another aspect of the invention, an immersive surveillance system has a plurality of cameras each producing a respective video of a respective portion of a site. An image processor is connected with the plurality of cameras and receives the video therefrom. The image processor produces an image rendered for a viewpoint based on a model of the site and combined with a plurality of the videos that are relevant to the viewpoint. A display device is coupled with the image processor and displays the rendered image. A view controller coupled to the image processor provides to it data defining the viewpoint to be displayed. The view controller is also coupled with and receives input from an interactive navigational component that allows a user to selectively modify the viewpoint.

According to a further aspect of the invention, a method comprises receiving data from an input device indicating a selection of a viewpoint and field of view for viewing at least some of the video from a plurality of cameras in a surveillance system. A subgroup of one or more of said cameras that are in locations such that those cameras can generate video relevant to the field of view is identified. The video from the subgroup of cameras is transmitted to a video processor. A video display is generated with said video processor by rendering images from a computer model of the site, wherein the images correspond to the field of view from the viewpoint of the site in which at least a portion of at least one of the videos is overlaid onto the computer model. The images are displayed to a viewer, and the video from at least some of the cameras that are not in the subgroup is caused to not be transmitted to the video rendering system, thereby reducing the amount of data being transmitted to the video processor.

According to another aspect of the invention, a method for a surveillance system comprises recording the data streams of cameras of the system on one or more recorders. The data streams are recorded together in synchronized format, with each frame having a time stamp indicative of a time when the real-time image was made by the associated camera. There is communication with the recorders so as to cause the recorders to transmit the recorded data streams of the cameras to a video processor. The recorded data streams are received and the frames thereof synchronized based on the time stamps thereof. Data is received from an input device indicating a selection of a viewpoint and field of view for viewing at least some of the video from the cameras. A video display is generated with the video processor by rendering images from a computer model of the site, wherein the images correspond to the field of view from the viewpoint of the site in which at least a portion of at least two of the videos is overlaid onto the computer model. For each image rendered the video overlayed thereon is from frames that have time stamps all of which indicate the same time period. The images are displayed to a viewer.

According to still another method of the invention, the recorded data streams of cameras are transmitted to a video processor. Data is received from an input device data indicating a selection of a viewpoint and field of view for viewing at least some of the video from the cameras. A video display is generated with the video processor by rendering images from a computer model of the site. The images correspond to the field of view from said viewpoint of the site in which at least a portion of at least two of the videos is overlaid onto the computer model. The images are displayed to a viewer. Input indicative of a change of the viewpoint and/or field of view is received. The input is constrained such that an operator can only enter changes of the point of view or the viewpoint to a new field of view that are limited subset of all possible changes. The limited subset corresponds to a path through the site.

### BRIEF DESCRIPTION OF THE DRAWINGS

FIG. 1 shows a diagram illustrating how the traditional mode of operation in a video control room is transformed into a visualization environment for global multi-camera visualization and effective breach handling;

FIG. 2 illustrates a module that provides a comprehensive set of tools to assess a threat;

FIG. 3 illustrates the video overlay that is presented on a high-resolution screen with control interfaces to the DVR and PTZ units;

FIG. 4 illustrates the information that is presented to the user as highlighted icons over a map display and as a textual list view;

FIG. 5 illustrates the regions that are color coated to indicate if an alarm is active or not;

FIG. 6 illustrates a scaleable system architecture for the Blanket of Video Camera System a few cameras or a few hundred cameras quickly.

FIG. 7 illustrates a View Selection System of the present invention;

FIG. 8 is a diagram of synchronized data capture, replay and display in a system of the invention;

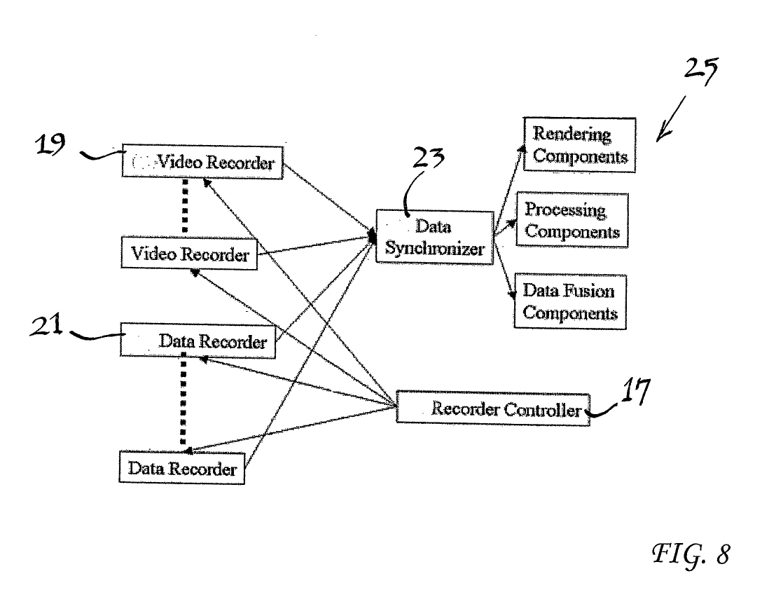

FIG. 9 is a diagram of a data integrator and display in such a system;

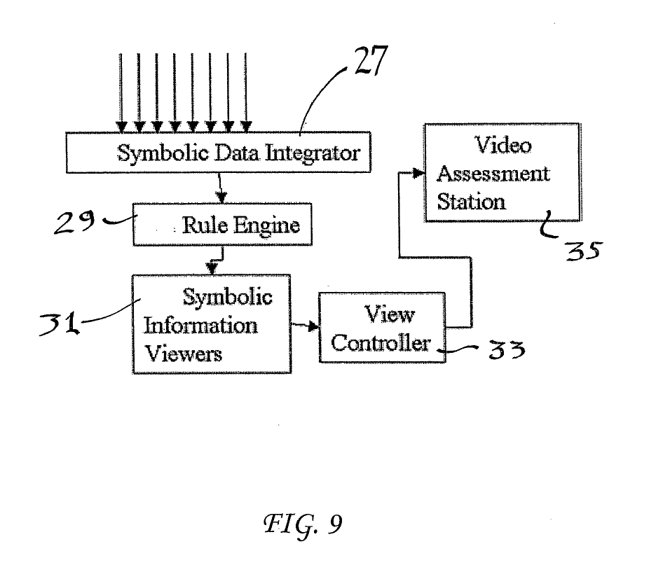

FIG. 10 shows a map-based display used with an immersive video system;

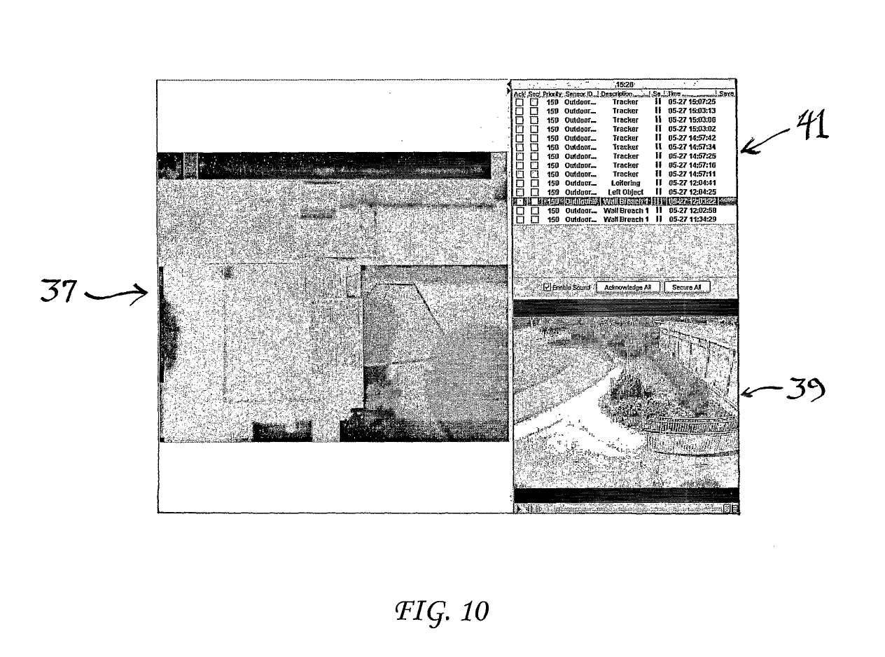

FIG. 11 shows the software architecture of the system.

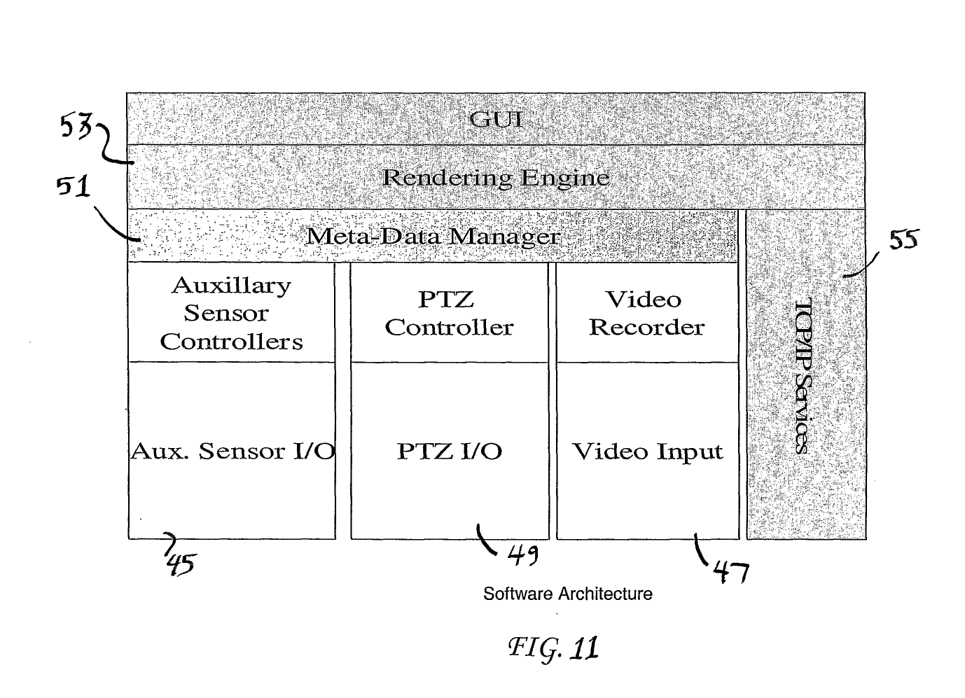

To facilitate understanding, identical reference numerals have been used, wherever possible, to designate identical elements that are common to the figures.

### DETAILED DESCRIPTION

The need for effective surveillance and security military installations or other secure locations is more pressing than ever. Effective day-to-day operations need to continue along with reliable security and effective response to perimeter breaches and access control breaches. Video-based operations and surveillance are increasingly being deployed at military bases and other sensitive sites.

For instance at the Campbell Barracks in Heidelberg, Germany there are 54 installed cameras and the adjacent Mark Twain Village military quarters a planned installation would have over hundred cameras. Current modes of video operations only allow traditional modes of viewing videos on TV monitors without an awareness of a global 3D context of the environment. Furthermore, video-based breach detection is typically non-existent and video visualization is not directly connected to breach detection systems.

The VIDEO FLASHLIGHT™ Assessment (VFA), Alarm Assessment (AA) and Vision-Based Alarm (VBA) technologies can be used to provide: (i) comprehensive visualization of, for example, perimeter area by seamlessly multiplexing multiple videos onto a 3D model of the environment, and (ii) robust motion detection and other intelligent alarms such as perimeter breach, left object and loitering detection at these locations.

In the present application, reference is made to the immersive surveillance system named VIDEO FLASHLIGHT™, which is exemplary of an environment in which the invention herein may be advantageously applied, although it should be understood that the invention herein may be used in systems different from the VIDEO FLASHLIGHT™ system, with analogous benefits. VIDEO FLASHLIGHT™ is a system in which live video is mapped onto and combined with a 2D or 3D computer model of a site, and the operator can move a viewpoint through the scene and view the combined rendered imagery and appropriately applied live video from a variety of viewpoints in the scene space.

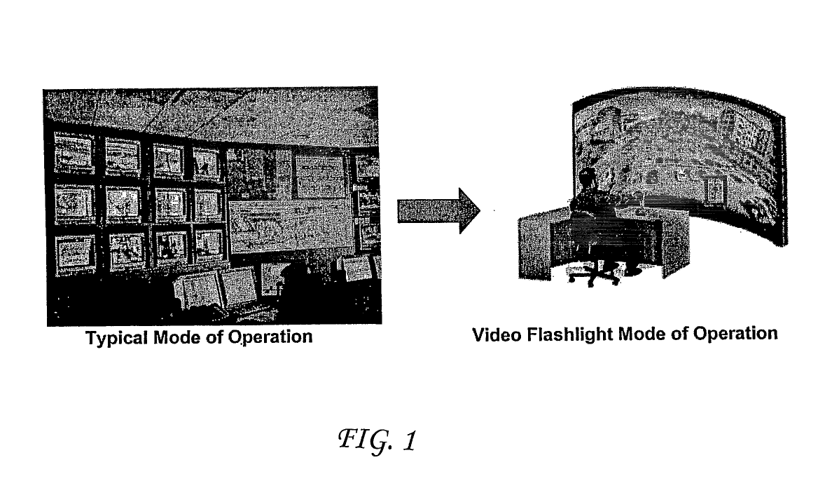

In a surveillance system of this type, cameras can provide comprehensive coverage of the area of interest. The videos are recorded continuously. The videos are rendered seamlessly onto a 3D model of the airport or other location to provide global contextual visualization. Automatic Video-Based Alarms can detect breaches of security, for example at the gates and fences. The Blanket of Video Camera (BVC) System will do continuous tracking of the responsible individual and will enable security personnel to then immersively navigate in space and in time to rewind back to the moment of the security breach and to then fast-forward in time to follow the individual up to the present moment. FIG. 1 shows how the traditional mode of operation in a video control room is transformed into a visualization environment for global multi-camera visualization and effective breach handling.

In summary, the BVC system provides the following capabilities. A single unified display shows real-time videos rendered seamlessly with respect to a 3D model of the environment. The user can freely navigate through the environment while viewing videos from multiple cameras with respect to the 3D model. The user can quickly and intuitively go back in time and review events that occurred in the past. The user can quickly get high-resolution video of an event by simply clicking on the model to steer one or more pan/tilt/zoom cameras to the location.

The system allows an operator to detect a security breach, and it enables the operator, to follow the individual(s) through tracking with multiple cameras. The system also enables security personnel to view the current location and the alarm event through the FA display or as archived video clips.

VIDEO FLASHLIGHT™ and Vision-Based Alarm Modules

The VIDEO FLASHLIGHT™ and Vision-Based Alarm system comprises four different modules:

Video Assessment (VIDEO FLASHLIGHT™ Rendering) Module.

Vision Alert Alarm Module

Alarm Assessment Module

System Health Information Module

The video assessment module (VIDEO FLASHLIGHT™) provides an integrated interface to view video draped on a 3D model. This enables a guard to navigate seamlessly through a large site and quickly assess any threats that occur within a large area. No other command and control system has this video overlay capability. The system overlays video from both fixed cameras and PTZ cameras, and utilizes DVR (digital video recorder) modules to record and playback events.

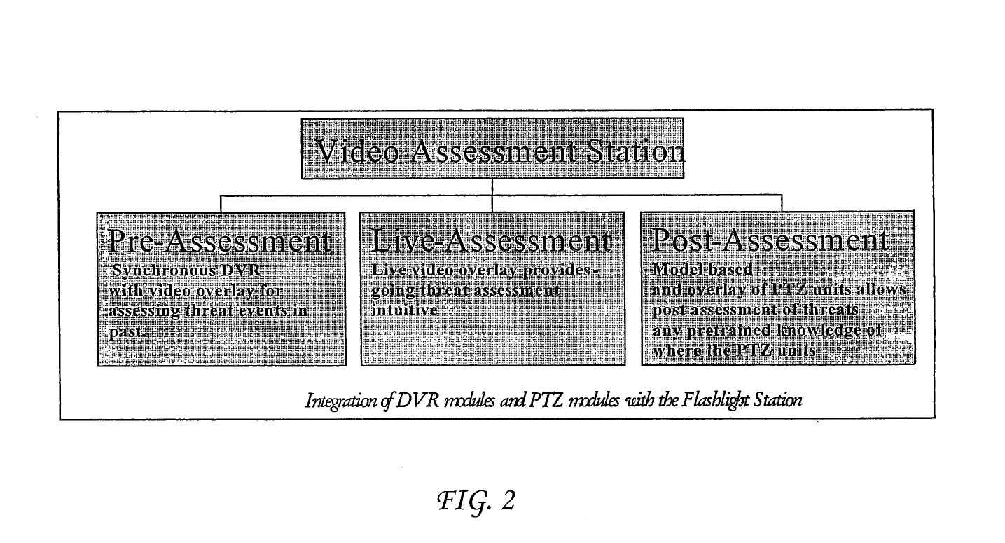

As best illustrated in FIG. 2, this module provides a comprehensive set of tools to assess a threat. An alarm situation is typically broken into 3 parts:

Pre-assessment: An alarm has occurred, and it is necessary to assess events leading to the alarm. Competing technology uses DVR devices or a pre-alarm buffer to store information from an alarm. However, the pre-alarm buffers are often too short, and the DVR devices only show video from one particular camera using complex control interfaces. The Video Assessment module on the other hand allows immersive synchronous viewing of all video streams at any time instant using an intuitive GUI.

Live-assessment: An alarm is occurring, and there is a need to quickly locate the live video showing the alarm, assess the situation, and respond quickly. In addition, there is a need to monitor areas surrounding the alarms simultaneously to check for additional activity. Most existing systems provide views of the scene using a bank of disparate monitors, and it takes time and familiarity with the scene to be able to switch between camera views to find the surrounding areas.

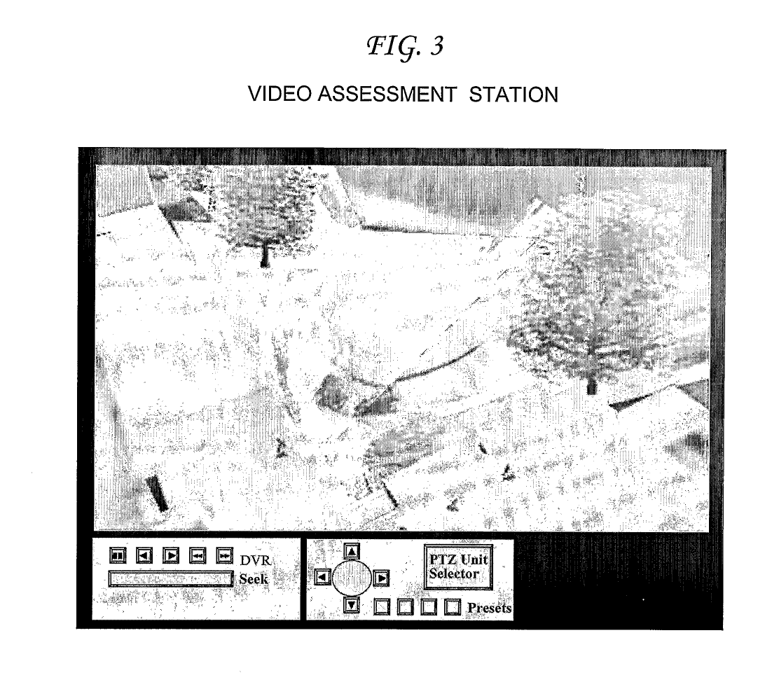

Post-assessment: An alarm situation has ended, and the point of interest has moved out of the field of view of the fixed cameras. There is a need to follow the point of interest through the scene. The VIDEO FLASHLIGHT™ Module allows simple, rapid control of PTZ cameras using intuitive mouse click control on the 3D model. The video overlay is presented on a high-resolution screen with control interfaces to the DVR and PTZ units as shown in FIG. 3.

Inputs and Outputs

The VIDEO FLASHLIGHT™ Video Assessment module takes the image data and sensor data that has been put into computer memory in a known format, takes the pose estimates that were computed during the initial model building, and drapes it over the 3D model. In summary, the inputs and outputs to the Video Assessment Module are:

Inputs:
Video from fixed cameras located at a known location and in a known format;
Video and Position Information from PTZ cameras location;
3D poses of each camera with respect to the model. (These 3D poses are recovered using calibration methods during system setup);
3D model of the scene (This 3D model is recovered using either an existing 3D model, commercial 3D model building methods, or any other computer-model-building methods)
A desired view given either by an operator using a joystick or keyboard, or controlled automatically by an alarm, configured by the user.

Outputs:
An image in memory showing the flashlight view from the desired view.
PTZ commands to control PTZ positions
DVR controls to go back and preview events in the past.

The main features in the Video Assessment system are:
Visualization of the 3D site model to provide a rich 3D context. (Navigation in Space)
Overlay of real-time video over the 3D model to provide video based assessment.
Synchronous control of multiple DVR units to seamlessly retrieve and overlay video on the 3D model. (Navigation in time)
Control and overlay of PTZ video by simple mouse click on the 3D model. No special knowledge of where the camera is needed by the guard to move the PTZ units. The system automatically decides which PTZ unit is best suited for viewing the area of interest.
Automated selection of video based on viewpoint selected allows the system to integrate video matrix switches to provide virtual access to a very large number of cameras.
Level-of-detail rendering engine provides seamless navigation across very large 3D sites.

User Interface for Video Assessment (VIDEO FLASHLIGHT™)

Visualization: There are two views that are presented to the user in the Video Assessment module, (a) a 3D render view and (b) a Map Inset View. 3D render view displays the site model with the video overlays or Video billboards located in 3D space. This provides detailed information of the site. Map inset view is a top down view of the site with camera footprint overlays. This view provides a overall context of site.

Navigation:

Navigating through preferred viewpoints: The navigation through the site is provided using a cycle of preferred viewpoints. Left and right arrow keys allow you to fly between these key viewpoints. There are multiple such viewpoint cycles defined at different levels of detail (different zoom levels in the viewpoint). Up and down arrow keys are used to navigate through these zoom levels.

Navigation with the mouse: The user can left click on any of the video overlays to center that point within the preferred viewpoint. This allows the user to easily track a moving object that is moving across the fields of view of overlapping cameras. The user can left click on the video billboards to transition into a preferred overlaid viewpoint.

Navigation with the map inset: The user can left click on the footprints of the map inset to move to the preferred viewpoint for a particular camera. User can also left click and drag the mouse to identify a set of footprints to obtain a preferred zoomed out view of the site.

PTZ Controls:

Moving PTZ with mouse: The user can shift left click on the model or the map inset view to move the PTZ units to a specific location. The system then automatically determines which PTZ units are suitable for viewing that point and moves those PTZs accordingly to look at that location. While pressing the shift button, the user can rotate the mouse wheel to zoom in or out from the nominal zoom the system had previously selected. When viewing the PTZ video the system will automatically center the view on the primary PTZ viewpoint.

Moving between PTZs: When multiple PTZ units see a particular point the preferred view would be assigned to the closest PTZ unit to that point. The use can switch the preferred view to other PTZ units that see that point by using the left and right arrow keys.

Controlling PTZ from Birds-Eye-View: In this mode, user can control the PTZ while seeing all the fixed camera views and a birds eye view of the campus. Using the up and down arrow keys the guard can move between birds-eye-view and zoomed in views of the PTZ video. The controlling of the PTZ is done by shift clicking on the site or the inset map as described above.

DVR Controls:

Selecting the DVR Control Panel: The user can press ctrl-v to bring up a panel to control the DVR units in the system.

DVR play controls: By default the DVR subsystem streams live video to the video assessment station, i.e., the video station where the immersive display is shown to the user. The user can select the pause button stop the video at the current point in time. The user then switches to the DVR mode. In the DVR mode the user is able to synchronously play forward or backward in time until the limits of the recorded video is reached. While the video is playing in the DVR mode the user is able to navigate through the site as described in the Navigation section above.

DVR seek controls: The user can seek all the DVR controlled videos to a given point in time by specifying the time of interest where you want move to. The system would move all the video to that point in time and then pause until the user selects another DVR command.

Alarm Assessment Module

Map-Based Browser—Overview The map-based browser is a visualization tool for wide areas. Its primary component is a scrollable and zoomable orthographic map containing different components for representing sensors (fixed cameras, ptz cameras, fence sensors) and symbolic information (text, system health, boundary lines, an object's movement over time.)

Accompanying this view is a scaled down instance of the map which is neither scrollable nor zoomable whose purpose is to outline the field of view port for the large view, display the status of components not in the field of view of the large view, and provide another method for changing the large view's view port.

Components in the map-based display are capable of having different behaviors and functions based on the visualization application. For alarm assessment, components are capable of changing color and blinking based on the alarm state of the sensor the visual component represents. When there is an unacknowledged alarm at the sensor, it will be red and blinking on the map based display. Once all the alarms for this sensor are acknowledged, the component will be red but will no longer blink. After all the alarms for the sensors have been secured, the component will return to its normal green color. Sensors can also be disabled through the map-based component after which they will be yellow until they are enabled again.

Other modules are able to access components in the map display by sending events through an API (application program interface). The alarm list is one such module that aggregates alarms across many alarm stations and presents it as a textual list to the user for alarm assessment. Using this API, the alarm list is capable of changing the states of map-based components whereupon such change the component will change color and blink. The alarm list is capable of sorting alarms by time, priority, sensor name, or type of alarm. It is also capable of controlling VideoFlashlights to view video that occurred at the time of an alarm. For video-based alarm, the alarm list is capable of displaying the video that caused the alarm in the video viewing window and saving the video that caused the alarm to disk.

Map-based Browser Interaction with VideoFlashlights

Components in the map-based browser have the ability to control the virtual view and video feed to the VideoFlashlights display through API exposed over a TCP/IP connection. This offers the user another method for navigating a 3D scene in Video Flashlights. In addition to changing the virtual view, components in the map-based display can also control the DVR's and create a virtual tour where the camera changes its location after a specified amount of time has elapsed. This last function allows for video flashlights to create personalized tours that follow a person through a 3D scene.

Map-Based Browser Display

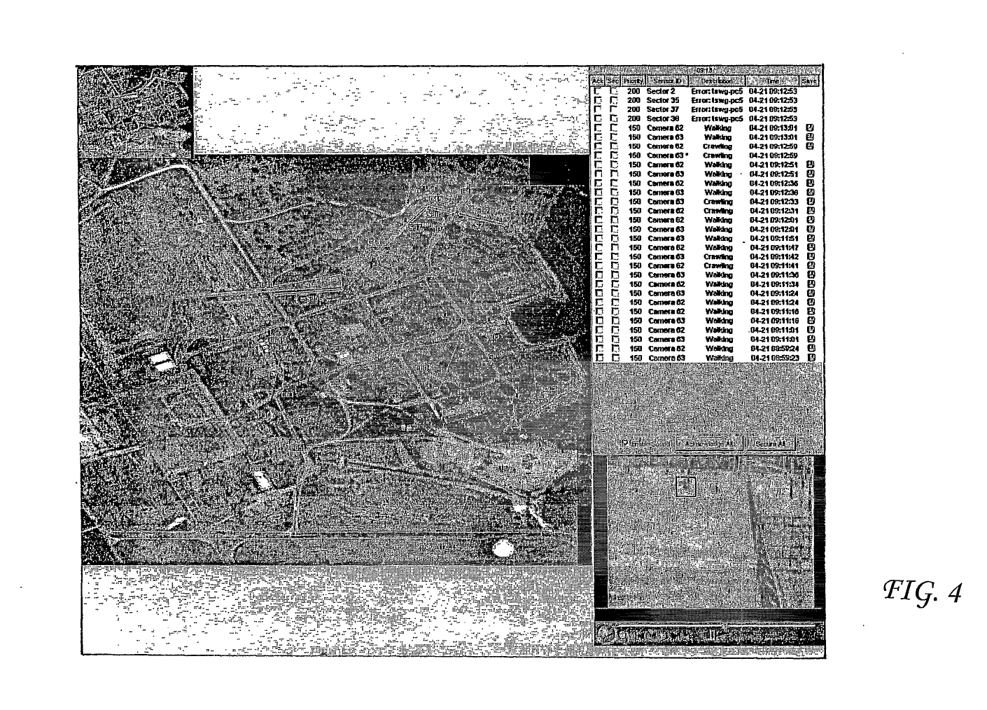

Alarm assessment station integrates multiple alarms across multiple machines and presents it to the guard. The information is presented to the user as highlighted icons over a map display and as a textual list view (FIG. 4). The map view enables the guard to identify the threat in its correct spatial context. It also acts as a hyper-link to control the Video-Assessment station to immediately slave the video to look at the areas of interest. The list view enables the user to evaluate the Alarm as to the type of alarm, the time of alarm and also to watch annotated video clips for any alarms.

Key Features and Specifications

Key features of the AA station are as follows:
It presents the user with alarms from Vision Alert stations, dry contact inputs, and other custom alarms that are integrated into the system.
Symbolic information is overlaid on a 2D site map to provide context in which an alarm is occurring.
Textual information is displayed sorted by time or priority to get detailed information on any alarm.
Slave the VIDEO FLASHLIGHT™ Station to automatically navigate to the Alarm specific viewpoint guided by the user input.
Preview annotated video clips of the actual alarms.
Save video clips for later use.

The user can administer the alarms by acknowledging alarms, and once an alarm condition is resolved, recurring the alarm. The user may also disable specific alarms to enable activity that is pre-planned from happening without generating alarms.

User Interface for Alarm Assessment module

Visualization:

Alarm list view integrates alarms for all Vision Alert Stations and external alarm sources or system failures into a single list. This list updated in real time. The list can be sorted by time or by alarm priorities.

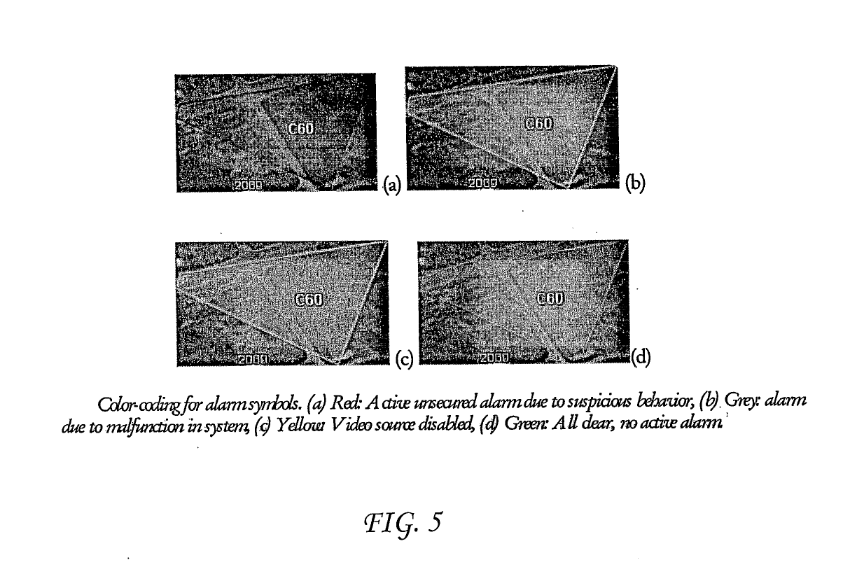

Map view shows on the maps where alarms are occurring. The user can scroll around the map or select areas by using the inset map. The Map view assigns alarms into marked symbolic regions to indicate where the alarm is happening. These regions are color coded to indicate if an alarm is active or not, as illustrated in FIG. 5. The preferred color-coding for alarm symbols is (a) Red: Active unsecured alarm due to suspicious behavior, (b) Grey: alarm due to malfunction in system, (c) Yellow: Video source disabled, and (d) Green: All clear, no active alarm.

Video preview: For video based alarms a preview clip of the activity is also available. These can be previewed in the video clip window.

Alarm Acknowledgement:

In the list view, user is able to acknowledge alarms to indicate he has observed. He can acknowledge alarms individually or he can secure all alarms on a particular sensor from the map view by right clicking on to get a pop-up menu and selecting acknowledge.

If the alarm condition has been resolved the user can indicate this by selecting the secure option in the list view. Once an alarm is secured it will be removed from the list view. The user may secure all the alarms for a particular sensor by right clicking on the region to get a pop-up menu and selecting the secure option. The will clear all the alarms for that sensor in the list view as well.

In addition the user can disable alarms from any sensor by using the pop-up menu and selecting the disable option. Any new alarm will automatically be acknowledged and secured for all disabled sources.

Video Assessment station control:

The user can move the Video Assessment station to a preferred view from the map view by left clicking on the region marked for a particular sensor. The map view control will send a navigation command to the video assessment station to move it. The user typically will click on an active alarm area to assess the situation using the Video Assessment module.

Video of Flashlight System Architecture & Hardware Implementation

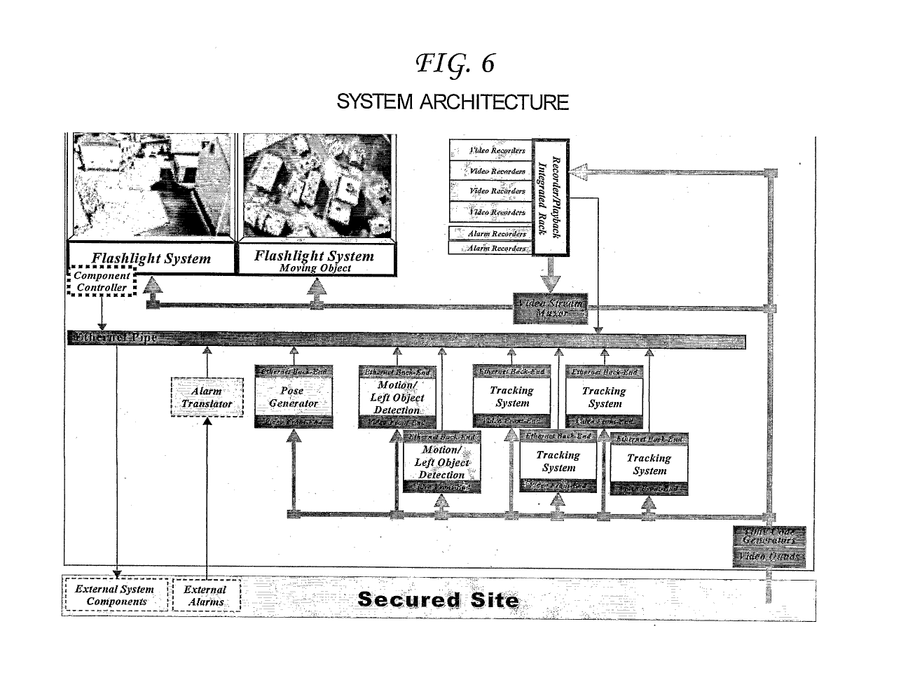

A scaleable system architecture has been developed for the Blanket of Video Camera System a few cameras or a few hundred cameras quickly (FIG. 6). The invention is based on having modular filters that can be interconnected to stream data between them. These filters can be sources (video capture devices, PTZ communicators, Database readers etc), transforms (Algorithm modules such as motion detectors, trackers) or sinks (such as rendering engines, database writers). These are built with inherent threading capability allowing multiple components to run in parallel. This allows the system to optimally use resources available on multi-processor platforms.

The architecture also provides sources and sinks that can send and receive streaming data across the network. This allows the system to be easily distributed across multiple PC workstations with simple configuration changes.

The filter modules are dynamically loaded at run time based on simple XML based configuration files. These define the connectivity between modules and define each filters specific behaviors. This allows an integrator to rapidly configure variety of different end-user applications that spans across multiple machines without having to modify any code.

Key Features of the System Architecture are:

System Scalability Capable of connecting across multiple processors, multiple machines.

Component Modularity The modular architecture keeps clear separations between software modules, with a mechanism of streaming data between them. Each of the modules are defined as a filter with an common interface to stream data between them.

Component Upgradability It is easy to replace components of the system without affecting the rest of the system infrastructure.

Data Streaming Architecture: Based on streaming data between modules in the system. Has an inherent understanding of time across the system and is able to synchronize and merge data from multiple sources.

Data Storage Architecture: Ability to simultaneously record and playback multiple meta-data streams per processor. Provides seek and review capabilities at each node, which can be driven by Map/Model based display and other clients. Power by back-end SQL database engine.

The system of the invention provides for efficient communication with the sensors of the system, which are generally cameras, but may be other types of sensors, such as smoke or fire detectors, motion detectors, door open sensors, or any of a variety of security sensors. Similarly the data from the sensors is generally video, but can also be other sorts of data such as alarm indications of detected motion or intrusion, fire, or any other sensor data.

A key requirement of a surveillance system is to be able to select the data being observed at any given time. Video cameras may stream tens, hundreds or thousands of video sequences. The view selection system herein is a means for visualizing, managing, storing, replaying, and analyzing this video data as well as data from other sensors.

View Selection System

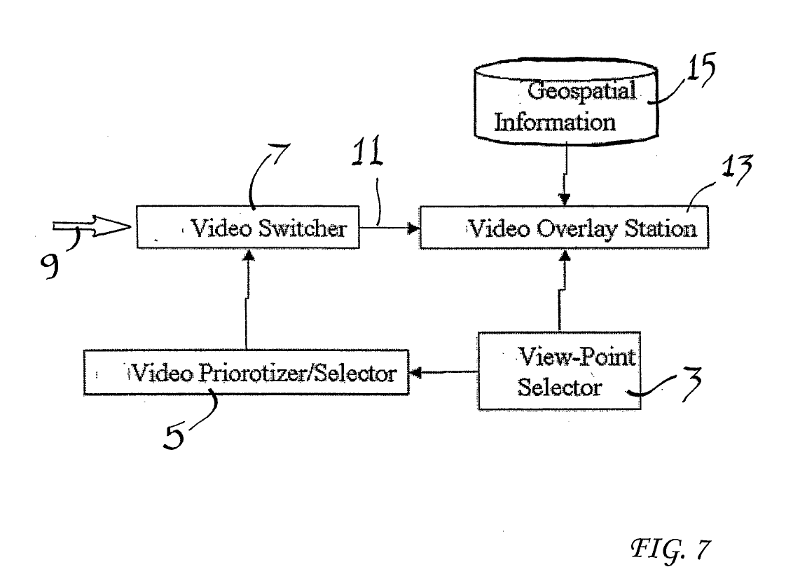

FIG. 7 illustrates selection criteria for video. Rather than enter individual sensor camera numbers (for example, camera 1, camera 2 camera, 3, etc.), the display of surveillance data is based on a view-point selector 3 that provides a selected virtual-camera position or viewpoint, meaning a set of data defining a point and field of view from that point, to the system to indicate the appropriate real-time view of the surveillance data to be displayed. The virtual-camera position can be derived from operator input, such as electronic data received from, e.g., an interactive station with an input device such as a joystick, or from the output of an alarm sensor, as an automated response to an event not in control of the operator.

Once the viewpoint is selected, the system then automatically computes which sensors are relevant for the field of view for that particular viewpoint. In the preferred embodiment, the system computes which subset of the system's sensors appear in the field of view of the video overlay area of regard with a video prioritizer/selector 5, which is coupled with the viewpoint selector 3 and receives therefrom data defining the virtual-camera viewpoint. The system via the video prioritizer/selector 5 then dynamically switches to the chosen sensors, i.e., the subset of relevant sensors, and avoids switching to the other sensors of the system by control of a video switcher 7. The video switcher 7 is coupled to the inputs of all the sensors (including cameras) in the system, which generate a large number of video or data feeds 9. Based on control from the selector 5, the switcher 7 switches on the communication link to carry the data feeds from the subset of relevant sensors, and to prevent transmission of the data feeds from the other sensors, so as to transmit only a reduced set of the data feeds 11 that are relevant to the virtual-camera viewpoint selected to video overlay station 13.

According to one preferred embodiment, the switcher 7 is an analog matrix switcher controlled by video prioritizer/selector 5 so as to switch a smaller number of video feeds 11 from an original larger set 9 into the video overlay station 13. This system is used especially when the feeds are analog video that is transmitted to the video assessment station for display over a limited set of hard wired lines. In such a system, the flow of the analog signals from the video cameras that are not relevant to the present field of view are switched off so that they do not enter the wires to the video assessment station, and the video feeds from the cameras that are relevant are physically switched on so as to pass through those connecting wires.

Alternatively, the video cameras may produce digital video, and this can be transmitted to digital video servers connected to a local area network linking them to the video assessment station, so that the digital video can be streamed to the video assessment station over the network. In such a system, the video switcher is part of the video assessment station, and it communicates with the individual digital video server over the network. If the server has a camera that is relevant, the switcher directs it to stream that video to the video assessment station. If the video is not relevant, the switcher sends a command to the video server to not send its video. The result is a reduction in traffic on the network, and greater efficiency in transmitting the relevant video to the video station for display.

The video is shown rendered on top of a 2D or 3D model of the scene, i.e., in an immersive video system, such as disclosed in U.S. published patent application 2003/0085992. The video overlay station 13 produces the video that constitutes the real-time immersive surveillance system display by combining the relevant data feeds 11, especially video imagery, with real-time rendered images of views created by a rendering system using a 2-D, or preferably 3-D, model of the site of the system, which can also be generally referred to as geospatial information, and is preferably store stored on a data storage device 15 accessible to the rendering component of the video overlay station 13. The relevant geospatial information to be shown rendered in each screen image is determined by viewpoint selector 3.

The video overlay station 13 prepares each image of the display video by applying, e.g., as a texture, the relevant video imagery to the rendered image in appropriate portions of the field of view. In addition, geospatial information is selected in the same way. The viewpoint selector determines which geospatial information is shown.

Once the video for the display is rendered and combined with the relevant sensor data streams, it is sent to a display device to be displayed to the operator.

These four blocks, video selector 3, video prioritizer/selector 5, video switcher 7, and video overlay station 13, provide for handling the display of potentially thousands of camera views.

One of skill in the art will readily understand that these functions may be supported on a single computerized system with their functions carried out largely by software, or they may be distributed computerized components discretely performing their respective tasks. Where the system relies on a network to transmit video to the video station, then it is preferred that the view point selector 3, the video selector, the video switcher 7 and the video overlay and rendering station all be expressed on the video station computer itself using software modules for each.

If the system is more reliant on hard-wired video feeds and non-networked or analog communications, it is better that the components be discrete circuits, with the video switcher being linked by wire to an actual physical switch near the source of the video to turn it off and save bandwidth when the video is irrelevant to the selected field of view.

Synchronized Data Capture, Replay and Display

With the capability to visualize live data from thousands of sensors, there is a need to store the data in a way that allows it to be replayed just as though the data were live.

Most digital video systems store data from each camera separately. However, according to the present embodiment, the system is configured to synchronously record video data, synchronously read it back, and display it in the immersive surveillance (preferably VIDEO FLASHLIGHT™) display.

FIG. 2 shows a block diagram of synchronized data capture, replay and display in VIDEO FLASHLIGHT™. A recorder controller 17 synchronizes the recording of all data, in which each frame of stored data includes data, a time stamp, identifying the time when it was created. In the preferred embodiment, this synchronized recording is performed by Ethernet control of DVR devices 19, 21.

The recorder controller 17 also controls playback of the DVR devices, and ensures that the record and playback times are initiated at exactly the same time. On playback, recorder controller 17 causes the DVR devices to play back the relevant video to a selected virtual camera viewpoint starting from an operator-selected point in time. The data is streamed over the local network to a data synchronizer 23 that buffers the played-back data to handle any real-time slip of the data reading, reads information such as the time-stamps to correctly synchronize multiple data streams so that all frames of the various recorded data streams are from the same time period, and then distributes the synchronized data to the immersive surveillance display system, e.g., VIDEO FLASHLIGHT™, and to any other components in the system, e.g., rendering components, processing components, and data fusion components, generally indicated at 27.

In an analog embodiment, the analog video from the cameras is brought to a circuit rack, where it is split. One part of the video goes to the Map Viewer station, as discussed above. The other part goes with three other camera's video through a cord box to the recorder, which stores all four video feeds in a synchronized regimen. The video is recorded and also, if relevant to the current point of view, is transmitted via hard wire to the video station for rendering into the immersive display by VIDEO FLASHLIGHT™.

In a more digital environment, there are a number of digital video servers attached each to about four to twelve of the cameras. The cameras are connected to a digital video server connected to the network of the surveillance system. The digital video server has connected thereto, usually in the same physical location, a digital video recorder (DVR) that stores the video from the cameras. The server streams the video to the video station for application to the rendered images for the immersive display, if relevant, and does not transmit the video if the video switcher, discussed above, directs it not to.

In the same way that live video data is applied to the immersive surveillance display as discussed above, the recorded synchronized data is incorporated in a real-time immersive surveillance playback display displayed to the operator. The operator is enabled to move through the model of the scene and view the scene rendered from his selected viewpoint, and using video or other data from the time period of interest.

The recorder controller and the data synchronizer are preferably separate dedicated computerized systems, but may be supported in one or more computer systems or electronic components, and the functions thereof may be accomplished by hardware and/or software in those systems, as those of skill in the art will be readily understand.

Data Integrator and Display

Besides the video sensors, i.e., cameras, there can also be hundreds of thousands of non-video-based sensors in a system. Visualization and management of these sensors is also very important.

As best shown in FIG. 3, a Symbolic Data Integrator 27 collects data from different meta data source (such as video alarms, access control alarms, object tracks) in real-time. The rule engine 29 combines multiple pieces of information to generate complex situation decisions, and makes various determinations as a matter of automated response, dependent upon different sets of meta data inputs and predetermined response rules provided thereto. The rules may be based on the geo-location of the sensors for example, and may also be based on dynamic operator input.

A Symbolic Information Viewer 31 determines how to present the determinations of the rule engine 29 to the user (for example, color/icon). The results of the rule engine determinations are then, when appropriate, used to control the viewpoint of a Video Assessment Station through a View Controller Interface. For example, a certain type of alarm may automatically alert the operator and cause the operator's display device to display immediately an immersive surveillance display view from a virtual camera viewpoint looking at the location of the sensor transmitting the meta data identifying the alarm condition.

The components of this system may be separate electronic hardware, but may also be accomplished using appropriate software components in a computer system at or shared with the operator display terminal.

Constrained Navigation

An immersive surveillance display system provides a limitless means to navigate in space and time. In everyday use, however, only certain locations in space and time are relevant to the application at hand. The present system therefore applies a constrained navigation of space and time in the VIDEO FLASHLIGHT™ system. An analogy can be drawn between a car and a train; a train can only move along certain paths in space, whereas a car can move in an arbitrary number of paths.

One example of such an implementation is to limit easy viewing of locations where there is no sensor coverage. This is implemented by analyzing the desired viewpoint provided by the operator using an input device such as a joystick or a mouse click on a computer screen. The system computes the desired viewpoint by computing the change in 3D viewing position that would center the clicked point in the screen. The system then makes a determination whether the viewpoint contains any sensors that are or can potentially be visible, and, responsive to a determination that there is such a sensor, changes the viewpoint, while, responsive to a determination that there is no such sensor, the system will not change the viewpoint.

Hierarchies of constrained motions have also been developed, as disclosed later.

Map or Event-Based Navigation

As well as navigating inside the immersive video display itself, such as by mouse clicks on points in the display or a joystick, etc., the system allows an operator to navigate using externally directed events.

For example, as seen in the screen shot of FIG. 4, a VIDEO FLASHLIGHT™ display has a map display 37 in addition to the rendered immersive video display 39. The map display shows a list of alarms 41 as well as a map of the area. Simply by clicking on either a listed alarm or the map, the viewpoint is immediately changed to a new viewpoint corresponding to that location, and the VIDEO FLASHLIGHT™ display is rendered for the new viewpoint.

The map display 37 alters in color or an icon appears to indicate a sensor event, as in FIG. 4, a wall breach is detected. The operator may then click on that indicator on the map display 37 and the point of view for the immersive display 39 will immediately be changed to a pre-programmed viewpoint for that sensor event, which will then be displayed.

PTZ Control

The image processing system knows the (x,y,z) world coordinates of every pixel in every camera sensor as well as in the 3D model. When the user clicks with a mouse on a point on the display of the 2D or 3D immersive video model, the system identifies the optimal camera for viewing the field of view centered on that point.

In some cases the camera best located to view the location is a pan-tilt-zoom camera (PTZ), which may be pointed in a different direction from that necessary to view the desired location. In such a case, the system computes the position parameters (for example the mechanical pan, tilt, zoom angles of a directed pan, tilt, sensor), directs the PTZ to that location by transmitting appropriate electrical control signals to the camera over the network, and receives the PTZ video, which is inserted into the immersive surveillance display. Details of this process are discussed further below.

PTZ Hand-Off

As described above, the system knows the (x,y,z) world coordinates of every pixel in every camera sensor as well as in the 3D model. Because the position of the camera sensor is known, the system can choose which sensor to use based on the desired viewing requirements. For example, in the preferred embodiment, when a scene contains more than 1 PTZ camera the system automatically selects one or more PTZs based entirely or in part on the ground-projected-2D (e.g. latt long) or 3D coordinates of the PTZ locations and the point of interest.

In the preferred embodiment, the system computes the distance to the object from each PTZ based on their 2D or 3D coordinates, and chooses to use the PTZ that is nearest the object to view the object. Additional rules include accounting for occlusions from 3D objects that are modeled in the scene, as well as no-go areas for the pan, tilt, zoom values, and these rules are applied in a determination of which camera is optimal for viewing a particular selected point in the site.

PTZ Calibration

PTZs require calibration to the 3D scene. This calibration is performed by selecting 3D (x,y,z) points in the VIDEO FLASHLIGHT™ model that are visible from the PTZ. The PTZ is pointed to that location and the mechanical pan, tilt, zoom values are read and stored. This is repeated at several different points in the model, distributed around the location of the PTZ camera. A linear fit is then performed to the points separately in the pan, tilt and zoom spaces respectively. The zoom space is sometimes non-linear and a manufacturers or empirical look-up can be performed before fitting. The linear fit is performed dynamically each time the PTZ is requested to move. When a PTZ is requested to point at a 3D location, the pan and tilt angles in the model space (phi, theta) are computed for the desired location with respect to the PTZ location. Phi and theta are then computed for all the calibration points with respect to the PTZ location. Linear fits are then performed separately on the mechanical pan, tilt and zoom values stored from the time of calibration using weighted least squares that weights more strongly those calibration phis and thetas that are closer to the phi and theta corresponding to the desired location.

The least-squares fit uses the calibration phis and thetas as x coordinate inputs and uses the measured pan, tilt and zoom values from the PTZ as y coordinate values. The least-squares fit then recovers parameters that give an output ‘y’ value for a given input ‘x’ value. The phi and theta corresponding to the desired point is then fed into a computer program expressing the parameterized equation (the ‘x’ value) which then returns the mechanical pointing pan (and tilt, zoom) for the PTZ camera. These determined values are is then used to determine the appropriate electrical control signals to transmit to the PTZ unit to control its position, orientation and zoom.

Immersive Surveillance Display Indexing

A benefit of the integration of video and other information in the VIDEO FLASHLIGHT™ system is that data can be indexed in ways that were previously not possible. For example, if the VIDEO FLASHLIGHT™ system is connected to a license plate reader system that is installed at multiple checkpoints, then a simple query of the VIDEO FLASHLIGHT™ system (using the rule based system described earlier) can instantly show imagery of all instances of that vehicle. Typically this is a very laborious task.

VIDEO FLASHLIGHT™ is the “operating system” of sensors. Spatial and algorithmic fusion of sensors greatly enhances the probability of detection and probability of correct identification of a target in surveillance type applications. These sensors can be any passive or active type, including video, acoustic, seismic, magnetic, IR etc. . . .

FIG. 5 shows the software architecture of the system. Essentially all sensor information is fed to the system through sensor drivers and these are shown at the bottom of the graph. Auxiliary sensors 45 are any active/passive sensors, such as the ones listed above, to do effective surveillance on a site. The relevant information from all these sensors along with the live-video from fixed and PTZ cameras 47 and 49 are fed to a Meta-Data Manager 51 that fuses all this information.

There is rule-based processing in this level 51 that defines the basic artificial intelligence of the system. The rules have the ability to control any device 45, 47, or 49 under the meta-data manager 51, and can be rules such as “record video only when any door is opened on Corridor A”, “track any object with a PTZ camera automatically on Zone B”, or “Make VIDEO FLASHLIGHT™ fly and zoom onto a person that matches a profile, or iris-criteria”.

These rules have direct consequences on the view that is rendered by the 3D Rendering Engine 53 (on top of Meta-Data Manager, and receiving data therefrom for display), since it is usually the visual information that is verified at the end, and typically users/guards want to fly onto the objects of interest, zoom-in, and assess the situation further with the visual feedback provided by the system.

All the capabilities mentioned above can be used remotely with the TCP/IP Services available. This module 55 exposes the API to remote sites that may not have the equipment physically, but want to use the services. Remote users have the ability to see the output of the application as the local user does, since the rendered image is sent to the remote site in real-time.

This is also a means of compression of all the information (video sensors, auxiliary sensors and spatial information) into one portable format, i.e. the rendered real-time program output, since a user can assess all this information remotely as he would do locally without having any equipment except a screen and some sort of an input device like a keyboard. An example would be to access all this information with a hand-held computer.

The system has a display terminal on which the various display components of the system are displayed to the user, as is shown in FIG. 6. The display device includes a graphic user interface (a GUI) that displays, inter alia, the rendered video surveillance and data for the operator-selected viewpoint and accepts mouse, joystick or other inputs to change the viewpoint or otherwise supervise the system.

Viewpoint Navigation Control

In earlier designs of immersive surveillance systems, the user navigated freely in a 3D environment with no constraints on the viewpoint. In the present design, there are constraints on the user's potential viewpoints, thereby increasing the visual quality and decreasing user interaction complexity.

One of the drawbacks of a completely free navigation is that if the user is not familiar with the 3D controls (which is not an easy task since there are usually more than 7 parameters to control including position (x,y,z), rotation (pitch, azimuth, roll), and field-of-view, it is easy to get lost or to create unsatisfactory viewpoints. That is why the system assists the user in creating perfect viewpoints, since video projections are in discrete parts of a continuous environment and these parts should be visualized the best way possible. The assistance may be in the form of providing, through the operator console, viewpoint hierarchies, rotation by click and zoom, and map-based navigation, etc.

Viewpoint Hierarchy

Viewpoint hierarchy navigation takes advantage of the discrete nature of the video projections and essentially decreases the complexity of the user interaction from 7+ dimensions to about 4 or less depending on the application. This is done by creating a viewpoint hierarchy in the environment. One possible way of creating this hierarchy is as follows; the lowest level of the hierarchy represents the viewpoints exactly equivalent to the camera positions and orientations in the scene with possibly a bigger field of view to get a larger context. The higher level viewpoints show more and more camera clusters and the topmost node of the hierarchy represents a viewpoint that sees all the camera projections in the scene.

Once this hierarchy is set up, instead of controlling absolute parameters like position and orientation, user makes the simple decision of where to look in the scene and the system decides and creates the best view for the user using the hierarchy. The user can also explicitly go up or down the hierarchy or move to peer nodes; i.e. viewpoints laterally spaced in the hierarchy at the same level.

Since all nodes are perfect viewpoints that are selected carefully done beforehand depending on customer's needs, and depending camera configuration on the site, the user can navigate in the scene by moving from one view to another with a simple choice of low order complexity, and the visual quality is above some controlled threshold at all times.

Rotation by Clicking & Zoom

This navigation scheme makes the joystick unnecessary as a user interface device for the system, and a mouse is the preferred input device.

When the user is investigating a scene displayed as a view from a viewpoint, he can further control the viewpoint by clicking on the object of interest in the 3D scene. This input will cause a change in the viewpoint parameters such that the view is rotated, and the object clicked on is at the center of the view. Once the object is centered, zooming can be performed on it by additional input using the mouse. This object-centric navigation makes the navigation drastically more intuitive.

Map-Based View & Navigation

At times, when the user is looking towards a small part of the world, there is a need to see the “big picture”, have a bigger context, i.e., see the map of the site. This is particularly useful when the user quickly wants to switch to another part of the 3D scene, in response to an alarm happening.

In the VIDEO FLASHLIGHT™ system a user can access an orthographic map-view of the scene. In this view, all the resources in the scene, including various sensors, are represented with their current status. Video Sensors are also among those, and a user can create the optimum view he desires on the 3D scene by selecting one or multiple video sensors on this map-view by selecting their displayed footprints, and the system will respond accordingly by navigating automatically to the viewpoint that shows all these sensors.

PTZ Navigation Control

Pan Tilt Zoom (PTZ) cameras are typically fixed in one position and have the ability to rotate and zoom. PTZ cameras can be calibrated to a 3D environment, as explained in a previous section.

Derivation of Rotation & Zoom Parameters

Once calibration is performed, an image can be generated for any point in the 3D environment since that point and the position of the PTZ creates a line that constitutes a unique pan/tilt/zoom combination. Here zoom can be adjusted to “track” a specific size (human (˜2 m), car (−5 m), truck (˜15 m), etc. . . . ) and hence depending on the distance of the point from the PTZ, it adjusts the zoom accordingly. Zoom can be further adjusted later on, depending on the situation.

Controlling the PTZ & User Interaction

In the VIDEO FLASHLIGHT™ system, in order to investigate an area with a PTZ, user clicks on to that spot in the rendered image of the 3D environment. That position is used by the software to generate the rotation angles and the initial zoom. These parameters are sent to the PTZ controller unit. PTZ turns and zooms to the point. In the mean time, PTZ unit is sending back its immediate pan, tilt, zoom parameters and video feed. These parameters are converted back to the VIDEO FLASHLIGHT™ coordinate system to project the video onto the right spot and the ongoing video is used as the projected image. Hence the overall effect is the visualization of a PTZ swinging from one spot to another with the real-time image projected onto the 3D model.

An alternative is to control the PTZ pan/tilt/zoom with the keyboard strokes or any other input device without using the 3D model. This proves to be useful for derivative movements like panning/tilting while tracking a person where instead of continuously clicking on the person, user clicks on pre-assigned keys. (e.g. the arrow keys left/right/up/down/shift-up/shift-down can be mapped to pan-left/pan-right/tilt-up/tilt-down/zoom-in/zoom-out) . . . .

Visualizing the Scene while Controlling the PTZ

The control of PTZ by clicking on the 3D model and the visualization of the swinging PTZ camera is described on the section above. But the viewpoint from which to visualize this effect can be important. One ideal way is to have a viewpoint that is “locked” to the PTZ where the viewpoint from which the user sees the scene has the same position as the PTZ camera and rotates as the PTZ is rotating. The field-of-view is usually larger than the actual camera to give context to the user.

Another useful PTZ visualization is to select a viewpoint on a higher level in the viewpoint hierarchy (See Viewpoint Hierarchy). This way multiple fixed and PTZ cameras can be visualized from one viewpoint.

Multiple PTZs

When there are multiple PTZs in the scene, rules can be imposed onto the system as to which PTZ to use where, and in what situation. These rules can be in the form of range-maps, Pan/Tilt/Zoom diagrams, etc. If a view is desired for a particular point in the scene, the PTZ-set that passes all these tests for that point is used for consequent processes such like showing them in VIDEO FLASHLIGHT™ or sending them to a video matrix viewer.

3D-2D Billboarding

The Rendering Engine of VIDEO FLASHLIGHT™ normally projects video onto a 3D Scene for visualization. But especially when the field-of-view of the camera is too small and the observation point is too different from the camera, there is too much distortion when the video is projected onto the 3D environment. In order to still show the video and keep the spatial context, billboarding is introduced as a way to show the video feed on the scene. Billboard is shown in close proximity to the original camera location. Camera coverage area is also shown and linked to the billboard.

Distortion can be detected by multiple measures, including the shape morphology between the original and the projected image, image size differences, etc. . . .

Each billboard is essentially displayed as a screen hanging in the immersive imagery perpendicular to the viewer's line of sight, with the video displayed thereon from the camera that would otherwise be displayed as distorted in the immersive environment. Since billboards are 3D objects, the further the camera from the viewpoint, the smaller the billboard, hence spatial context is nicely preserved.

In an application where there are hundreds of cameras, billboarding can still prove to be really effective. In a 1600×1200 screen, as many as +250 billboards about an average size of 100×75 would be visible in one shot. Of course, in this magnitude, billboards will act as live textures for the whole scene.

While the foregoing is directed to embodiments of the present invention, other and further embodiments of the invention may be devised without departing from the basic scope thereof, and the scope thereof is determined by the claims that follow.

What is claimed is:

1. A surveillance system for a site, said system comprising:
a plurality of cameras each producing a respective video of a respective portion of the site;
a viewpoint selector configured to allow a user to selectively identify a viewpoint in said site from which to view the site or a part thereof;
a video processor coupled with the plurality of cameras so as to receive said videos therefrom;
said video processor having access to a computer model of the site and rendering from said computer model real-time images corresponding to a field of view of the site from said viewpoint and in which at least a portion of at least one of the videos is overlaid onto the computer model, said video processor displaying said images so as to be viewed in real time to a user; and
a video control system based on said viewpoint automatically selecting a subset of said plurality of cameras that is generating video relevant to the field of view of the site from the viewpoint rendered by the video processor, and causing video from said subset of cameras to be transmitted to said video processor.

2. The immersive surveillance system of claim 1 wherein the video control system includes a video switcher that permits transmission to the video processor of the video from the subset of cameras selected as relevant to the view and prevents transmission to the video processor of the video from at least some of the cameras of said plurality of cameras that are not in the subset of cameras.

3. The immersive surveillance system of claim 2 wherein the cameras stream the video thereof over a network through one or more servers to the video processor, and said video switcher communicates with said servers so as to prevent streaming over the network of at least some of the video of the cameras that are not in said subset of the cameras.

4. The immersive surveillance system of claim 2 wherein the cameras transmit the video thereof to the video processor via communication lines and the video switcher is an analog matrix switch device that switches off flow along said communications lines of at least some of the videos of the cameras that are not in said subset of cameras.

5. The immersive surveillance system of claim 1 wherein the video control system determines a distance between the viewpoint and each of the plurality of cameras, and selects said subset of the cameras so as to include the camera having the shortest distance to the viewpoint.

6. The immersive surveillance system of claim 1 wherein the viewpoint selector is an interactive display at a computer station through which the user can identify the viewpoint in said computer model while viewing said images on a display device.

7. The immersive surveillance system of claim 1 wherein the computer model is a 3-D model of the site.

8. The immersive surveillance system of claim 1, wherein the viewpoint selector receives an operator input or automatic signal in response to an event and changes the viewpoint to a second viewpoint in response thereto;
and the video control system based on said second viewpoint automatically selecting a second subset of said plurality of cameras that is generating video relevant to the view of the site from the second viewpoint rendered by the video processor, and causing video from said different subset of cameras to be transmitted to said video processor.

9. The immersive surveillance system of claim 8, wherein the viewpoint selector receives the operator input to change the viewpoint, and said change is a continuous movement of the viewpoint to said second viewpoint, and said continuous movement is constrained to a permitted viewing pathway by the viewpoint selector such that movement outside the viewing pathway is inhibited in spite of any operator input directing such movement.

10. The immersive surveillance system of claim 1, wherein at least one of said cameras is a PTZ camera having controllable direction or zoom parameters, and said video control system transmits a control signal to said PTZ camera such as to cause the camera to adjust the direction or zoom parameters of the PTZ camera so that said PTZ camera provides data relevant to the field of view.

11. A surveillance system for a site, said system comprising:
a plurality of cameras each generating a respective data stream, each data stream including a series of video frames each corresponding to a real-time image of a part of the site, each frame having a time stamp indicative of a time when the real-time image was made by the associated camera;
a recorder receiving and recording the data streams from the cameras;
a video processing system connected with the recorder and providing for playback of said recorded data streams therefrom, said video processing system having a renderer that during playback of the recorded data streams renders images for a view from a playback viewpoint of a model of the site and applies thereto the recorded data streams from at least two of the cameras relevant to the view;
the video processing system including a synchronizer receiving the recorded data streams from the recorder system during playback, said synchronizer distributing the recorded data streams to the renderer in synchronized form so that each image is rendered with video frames all of which were taken at the same time.

12. The immersive surveillance system of claim 11, wherein the synchronizer synchronizes the data streams based on the time stamps of the video frames thereof.

13. The immersive surveillance system of claim 12 wherein the recorder is coupled to a controller that causes the recorder to store the plurality of data streams in a synchronized format, and that reads the time stamps of the plurality of data streams to enable synchronization.

14. The immersive surveillance system of claim 11 wherein the model is a 3D model.

15. An immersive surveillance system comprising:
a plurality of cameras each producing a respective video of a respective portion of a site;
an image processor connected with the plurality of cameras and receiving the video therefrom, said image processor producing an image rendered for a viewpoint based on a model of the site and combined with a plurality of said videos that are relevant to said viewpoint;
a display device coupled the image processor and displaying the rendered image; and
a view controller coupled to the image processor and providing thereto data defining the viewpoint to be displayed, said view controller being coupled with and receiving input from an interactive navigational component that allows a user to selectively modify the viewpoint, said navigational component constraining the modification of the viewpoint to a preselected set of viewpoints.

16. The immersive surveillance system of claim 15 wherein the view controller computes a change in viewing position of the point.

17. The immersive surveillance system of claim 15 wherein, when the user modifies the viewpoint to a second viewpoint, the view controller determines whether any video in addition to the video relevant to the first viewpoint is relevant to the second viewpoint, and a second image is rendered for the second video using any additional video identified as relevant to the second viewpoint by the view controller.

18. A method for an immersive surveillance system having a plurality of cameras each producing respective video of a respective part of a site, and a viewing station with a display device displaying images so as to be viewed by a user, said method comprising:
receiving from an input device data indicating a selection of a viewpoint and field of view for viewing at least some of the video from the cameras;
identifying a subgroup of one or more of said cameras that are in locations such that those cameras can generate video relevant to the field of view;
transmitting the video from said subgroup of cameras to a video processor;
generating with said video processor a video display by rendering images from a computer model of the site, wherein said images correspond to the field of view from said viewpoint of the site in which at least a portion of at least one of the videos is overlaid onto the computer model;
displaying said images to a viewer; and
causing the video from at least some of the cameras that are not in said subgroup to not be transmitted to the video rendering system and thereby reducing the amount of data being transmitted to the video processor.

19. The method of claim 18, wherein the video from said subgroup of cameras is transmitted to the video processor through servers associated with said cameras over a network, and wherein the causing of video not to be transmitted is accomplished by communicating through said network to at least one server associated with at least one of said cameras that are not in the subgroup of said cameras so that the server does not transmit the video of said at least one camera.

20. The method of claim 18, and further comprising:
receiving input indicative of a change of the viewpoint and/or the field of view so that a new field of view and/or a new viewpoint is defined; and
determining a second subgroup of said cameras that can generate video relevant to said new field of view or new viewpoint;
causing the video from said second subgroup of said cameras to be transmitted to the video processor;
said video processor using the computer model and the video received to render new images for the new field of view or new viewpoint; and
wherein video from at least some of said cameras that are not in said second group is caused not to be transmitted to the video processor.

21. The method of claim 20, wherein said first and second groups have at least one of said cameras in common and each subgroup having at least one camera thereof that is not in the other subgroup.

22. The method of claim 20, wherein the subgroups each has only a respective one of said cameras therein.

23. The method of claim 18, wherein one of said cameras in said subgroup is a camera having a controllable direction or zoom, and said method further comprises transmitting to said camera a control signal such as to cause the camera to adjust the direction or zoom thereof.

24. A method for a surveillance system for a site having a plurality of cameras each generating a respective data stream of a series of video frames each corresponding to a real-time image of a part of the site, said method comprising:
recording the data streams of said cameras on one or more recorders, said data streams being recorded together in synchronized format, and with each frame having a time stamp indicative of a time when the real-time image was made by the associated camera;
communicating with said recorders so as to cause said recorders to transmit the recorded data streams of said cameras to a video processor;
receiving said recorded data streams and synchronizing the frames thereof based on the time stamps thereof;
receiving from an input device data indicating a selection of a viewpoint and field of view for viewing at least some of the video from the cameras;
generating with said video processor a video display by rendering images from a computer model of the site, wherein said images correspond to the field of view from said viewpoint of the site in which at least a portion of at least two of the videos is overlaid onto the computer model;
wherein, for each image rendered the video overlayed thereon is from frames that have time stamps all of which indicate the same time period; and
displaying said images to a viewer.

25. A method as in claim 24 wherein responsive to input received the video is played back selectively forward and backward.

26. The method of claim 25 wherein the playback is controlled from the video processor location by transmitting command signals to said recorders.

27. The method of claim 24 and further comprising receiving input directing a change of field of view and/or viewpoint to a new field of view, said video processor generating images from the computer model and the video for said new viewpoint and/or field of view.

28. A method for a surveillance system for a site having a plurality of cameras each generating a respective data stream of a series of video frames each corresponding to a real-time image of a part of the site, said method comprising:
transmitting the recorded data streams of said cameras to a video processor;
receiving from an input device data indicating a selection of a viewpoint and field of view for viewing at least some of the video from the cameras;
generating with said video processor a video display by rendering images from a computer model of the site, wherein said images correspond to the field of view from said viewpoint of the site in which at least a portion of at least two of the videos is overlaid onto the computer model; and
displaying said images to a viewer;
receiving input indicative of a change of said viewpoint and/or field of view, said input being constrained such that an operator can only enter changes of the point of view or the viewpoint to a new field of view that are limited subset of all possible changes, said limited subset corresponding to a path through said site.
